(19) United States
(12) Patent Application Publication
(10) Pub. No.: US 2025/0174404 A1
(43) Pub. Date: May 29, 2025

(54) Multilayer Electronic Component Including at Least One Via Connected to a Capacitor Outside Its Capacitive Area

(71) Applicant: KYOCERA AVX Components Corporation, Fountain Inn, SC (US)

(72) Inventors: Jonathan Herr, Taylors, SC (US); Cory Nelson, Simpsonville, SC (US); Marianne Berolini, Greer, SC (US)

(21) Appl. No.: 18/948,645

(22) Filed: Nov. 15, 2024

Related U.S. Application Data
(60) Provisional application No. 63/603,664, filed on Nov. 29, 2023.

(51) Int. Cl. H01G 4/30; H01G 2/06; H01G 4/14; H01G 4/232

(52) U.S. Cl. CPC H01G 4/30; H01G 2/065; H01G 4/14; H01G 4/232

(57) ABSTRACT

Multilayer electronic components and methods of forming multilayer electronic components are provided. For example, a multilayer electronic component includes a plurality of dielectric layers stacked in a Z-direction and comprising a dielectric material. The component also includes a first conductive layer overlying one of the plurality of dielectric layers and a second conductive layer overlying another of the plurality of dielectric layers and spaced apart from the first conductive layer in the Z-direction. The second conductive layer overlaps the first conductive layer in each of an X-direction and a Y-direction at an overlapping area to form a capacitor. The component further includes a via connected with one of the conductive layers at a location outside of the overlapping area. As another example, a via may connect with one conductive layer at a location opposite a non-conductive region formed in another conductive layer forming a capacitor with the one conductive layer.

### RELATED APPLICATION

The present application is based upon and claims priority to U.S. provisional patent application Ser. No. 63/603,664, having a filing date of Nov. 29, 2023, which is incorporated herein by reference.

### BACKGROUND OF THE DISCLOSURE

Electrical devices can include multilayer components having one or more capacitors. As one example, a multilayer component may be a multilayer filter including one or more capacitors. In at least some electrical devices, such capacitors may be useful for filtering high frequency signals, such as high frequency radio signal communication. The demand for increased data transmission speed for wireless connectivity has driven demand for high frequency components, including those configured to operate at high frequencies, including 5G spectrum frequencies. However, connecting the capacitor to one or more other elements using a via or the like can short the capacitor or otherwise create a power vulnerability, for example, if the via partially or fully punctures the capacitor and electrically connects the capacitor electrodes. As such, capacitor connections that avoid or prevent partial or full punctures of the capacitor would be welcomed in the art.

### SUMMARY OF THE DISCLOSURE

In accordance with one embodiment of the present disclosure, a multilayer electronic component is provided. The multilayer electronic component includes a plurality of dielectric layers stacked in a Z-direction that is perpendicular to each of an X-direction and a Y-direction, and the X-direction is perpendicular to the Y-direction. The plurality of dielectric layers comprise a dielectric material. The multilayer electronic component also includes a first conductive layer overlying one of the plurality of dielectric layers and a second conductive layer overlying another of the plurality of dielectric layers and spaced apart from the first conductive layer in the Z-direction. The second conductive layer overlaps the first conductive layer in each of the X-direction and the Y-direction at an overlapping area to form a capacitor. The multilayer electronic component further includes a first via connected with the first conductive layer at a first location outside of the overlapping area.

In accordance with another embodiment of the present disclosure, a method of forming a multilayer electronic component is provided. The method includes providing a plurality of dielectric layers; forming a first conductive layer overlying one of the plurality of dielectric layers; forming a second conductive layer overlying another of the plurality of dielectric layers and spaced apart from the first conductive layer in a Z-direction; stacking the plurality of dielectric layers such that the first conductive layer overlaps the second conductive layer in each of an X-direction and a Y-direction at an overlapping area to form a capacitor, the X-direction perpendicular to the Y-direction and each of the X-direction and the Y-direction perpendicular to the Z-direction; and forming a first via connected with the first conductive layer at a first location outside of the overlapping area.

In accordance with yet another embodiment of the present disclosure, a multilayer electronic component is provided. The multilayer electronic component includes a plurality of dielectric layers stacked in a Z-direction that is perpendicular to each of an X-direction and a Y-direction, and the X-direction is perpendicular to the Y-direction. The plurality of dielectric layers comprise a dielectric material. The multilayer electronic component further includes a first conductive layer overlying a first dielectric layer of the plurality of dielectric layers and a second conductive layer overlying a second dielectric layer of the plurality of dielectric layers and spaced apart from the first conductive layer in the Z-direction. The second conductive layer overlaps the first conductive layer in each of the X-direction and the Y-direction at an overlapping area to form a capacitor. The multilayer electronic component also includes a via connected with the first conductive layer and a non-conductive region defined on the second dielectric layer such that the second conductive layer surrounds the non-conductive region. The via connects with the first conductive layer at a location opposite the non-conductive region along the Z-direction.

### BRIEF DESCRIPTION OF THE DRAWINGS

A full and enabling disclosure of the present disclosure, including the best mode thereof, directed to one of ordinary skill in the art, is set forth more particularly in the remainder of the specification, which makes reference to the appended figures, in which:

FIG. 1A is a schematic side view of a portion of a multilayer electronic component including a capacitor connected with two vias;

FIG. 1B is a schematic perspective view of the capacitor of FIG. 1A according to one embodiment of the present disclosure;

FIG. 1C is a schematic perspective view of the capacitor of FIG. 1A according to another embodiment of the present disclosure;

FIG. 2A is a schematic side view of a portion of a multilayer electronic component including a capacitor connected with a via opposite a non-conductive region;

FIG. 2B is a schematic perspective view of the capacitor of FIG. 2A;

FIG. 2C is a schematic side view of a portion of a multilayer electronic component including a capacitor connected with a via opposite a non-conductive region according to another embodiment of the present disclosure;

FIG. 2D is a schematic side view of a portion of a multilayer electronic component including a capacitor connected with multiple vias, each via opposite a non-conductive region; and

FIG. 3 is a flow chart illustrating a method of forming multilayer electronic components according to embodiments of the present disclosure.

Repeat use of reference characters in the present specification and drawings is intended to represent same or analogous features or elements of the disclosure.

### DETAILED DESCRIPTION OF THE DISCLOSURE

It is to be understood by one of ordinary skill in the art that the present discussion is a description of exemplary embodiments only and is not intended as limiting the broader aspects of the present disclosure, which broader aspects are embodied in the exemplary construction.

Generally speaking, the present disclosure is directed to a multilayer electronic component including a capacitor connected with one or more vias arranged to avoid or prevent a full or partial puncture of a via through the capacitance area of the capacitor. The one or more vias may be connected to the capacitor outside of the capacitance area. For example, one or more vias may be connected with a respective conductive element of the capacitor at a region of conductive material that is outside of the capacitance area. As another example, a via may be connected with a first conductive element of the capacitor within the capacitance area, and a non-conductive region is defined within a second conductive element of the capacitor at a location opposite the via connected with the first conductive element along the stacking direction of the conductive elements.

More particularly, a multilayer electronic component may include a plurality of dielectric layers stacked in a Z-direction that is perpendicular to each of an X-direction and a Y-direction, where the X-direction is perpendicular to the Y-direction. The plurality of dielectric layers can include a dielectric material. A first conductive layer may overlie one of the plurality of dielectric layers, and a second conductive layer may overlie another of the plurality of dielectric layers and be spaced apart from the first conductive layer in the Z-direction. The second conductive layer may overlap the first conductive layer in each of the X-direction and the Y-direction at an overlapping area, or a capacitance area, to form a capacitor.

In some embodiments, a first via is connected with the first conductive layer at a first location outside of the overlapping area. In addition to a first via, the multilayer electronic component may also include a second via connected with the second conductive layer at a second location outside of the overlapping area. In other embodiments, a via is connected with the first conductive layer and a non-conductive region is defined on the second dielectric layer such that the second conductive layer surrounds the non-conductive region, and the via connects with the first conductive layer at a location opposite the non-conductive region along the Z-direction.

Thus, the multilayer electronic component includes a capacitor connected with one or more vias outside of the capacitor area, e.g., by moving via connections outside the perimeter of the overlapping area between conductive layers (i.e., capacitor plates) or by including a non-conductive region within the overlapping area and connecting a via opposite the non-conductive region. Designing via placement to be outside of the capacitor area can avoid or prevent a partial or full via puncture into the dielectric, which could create a power vulnerability such as a short. Avoiding or preventing such punctures can therefore provide a reliability improvement, as well as increase component yield (e.g., by eliminating a reason for rejecting a component at manufacture).

The conductive layers may include or be formed from a variety of conductive materials. For example, the conductive layers may include copper, nickel, gold, silver, or other metals or alloys. The conductive layers may be formed directly on the respective dielectric layers. Alternatively, one or more intermediate layers or coating may be arranged between the conductive layers and the respective dielectric layers. As used herein, “formed on” may refer to either a conductive layer that is directly formed on a dielectric layer or a conductive layer that overlies the dielectric layer with an intermediate layer or coating therebetween.

The conductive layers may be formed using a variety of suitable techniques. Subtractive, semi-additive or fully additive processes may be employed with panel or pattern electroplating of the conductive material followed by print and etch steps to define the patterned conductive layers. Photolithography, plating (e.g., electrolytic), sputtering, vacuum deposition, printing, or other techniques may be used to form the conductive layers. For example, a thin layer (e.g., a foil) of a conductive material may be adhered (e.g., laminated) to a surface of a dielectric layer. The thin layer of conductive material may be selectively etched using a mask and photolithography to produce a desired pattern of the conductive material on the surface of the dielectric material.

As described above, the multilayer electronic component may include one or more vias formed in one or more of the dielectric layers. A via may electrically connect a conductive layer on one dielectric layer with a conductive layer on another dielectric layer of the multilayer electronic component. For example, the one or more vias may route in signals to the overlapping first and second conductive layers to produce capacitance between the layers. The one or more vias may include a variety of conductive materials, such as copper, nickel, gold, silver, or other metals or alloys. One or more vias of the multilayer electronic component may be formed by drilling (e.g., mechanical drilling, laser drilling, etc.) through holes and plating the through holes with a conductive material, for example using electroless plating or seeded copper. For instance, the interior surfaces of the through holes may be plated such that the vias are hollow. Alternatively, or additionally, one or more vias of the multilayer electronic component may be filled with conductive material such that a solid column of conductive material is formed.

In embodiments including at least two vias connected to respective conductive layers at different locations including a first location and a second location, the first location may be offset from the second location along at least one of the X-direction or the Y-direction. For example, the first location, where a first via may be connected with a first conductive layer, may be offset from the second location, where a second via may be connected with a second conductive layer, along both the X-direction and the Y-direction, only the X-direction, or only the Y-direction.

In some embodiments, the first conductive layer includes a first section that defines the first location and the second conductive layer includes a second section that defines the second location. The first section and the second section may be spaced apart from one another along one or both of the X-direction and the Y-direction. In some embodiments, the first location and the second location are spaced apart by a spacing distance in the X-direction. The overlapping area may have a length in the X-direction that is less than the spacing distance, but in other embodiments, the overlapping area may have a length in the X-direction that is greater than the spacing distance, such as when the first and second locations are not opposite one another along the X-direction. In some embodiments, the first location and the second location are spaced apart by a spacing distance in the Y-direction. The overlapping area may have a width in the Y-direction that is less than the spacing distance, but in other embodiments, the overlapping area may have a width in the Y-direction that is greater than the spacing distance, such as when the first and second locations are not opposite one another along the Y-direction. The spacing distance along either or both of the X-direction or Y-direction may be measured, for example, between a center of the first via and a center of the second via. However, it will be appreciated that the spacing distances may be measured in other ways as well, such as between a respective edge of the first via and a respective edge of the second via or in any other appropriate manner.

The overlapping area that defines the capacitor may include a first side and a second side opposite the first side along the X-direction. For example, the overlapping area may have a perimeter including a first side and a second side opposite the first side along the X-direction and a third side and a fourth side opposite the third side along the Y-direction. In some embodiments, the first location is defined adjacent the first side and the second location is defined adjacent the second side. In other embodiments, both the first location and the second location are defined adjacent one of the first side or the second side. In such embodiments, the first location and the second location may be spaced apart from one another along the Y-direction.

The overlapping area that defines the capacitor may include a third side and a fourth side opposite the third side along the Y-direction. In some embodiments, the first location is defined adjacent the third side and the second location is defined adjacent the fourth side. In other embodiments, both the first location and the second location are defined adjacent one of the third side or the fourth side, and the first location and the second location may be spaced apart from one another along the X-direction.

It will be appreciated that, in embodiments where a first via and a second via are connected to opposite conductive layers or plates of the capacitor, on the same side of the capacitor (such as one of the first side, second side, third side, or fourth side described above), the first via and the second via are offset from one another to avoid or prevent partial or full punch through of a via that could lead to a short or other power vulnerability as described herein. For instance, in embodiments in which the first via is connected to the first conductive layer at a first location defined along the first side of the overlapping area and the second via is connected to the second conductive layer at a second location defined along the first side of the overlapping area, the first location and the second location may be spaced apart from one another along the Y-direction to offset the first via from the second via. Thus, if the first via or the second via fully or partially punches through, e.g., into the dielectric separating the first location from the second location along the Z-direction, the possibility of a power vulnerability such as a short can be avoided because the first location and the second location are at least separated from one another along the Y-direction. In some embodiments, the first location and the second location may also be separated from one another along the X-direction, even if the first location and the second location are both defined adjacent to the same side (e.g., the first side or the second side) of the overlapping area.

In some embodiments, the multilayer electronic component includes a non-conductive region surrounded by the second conductive layer. For example, the non-conductive region may overlie the same dielectric layer as the second conductive layer, and the second conductive layer may be defined around the non-conductive region. The non-conductive region may be formed from the dielectric material of the plurality of dielectric layers, a different dielectric material than the dielectric material used to form the plurality of dielectric layers, or another material that is electrically non-conductive. For instance, the conductive material forming the second conductive layer over the respective dielectric layer may be removed or omitted to define the non-conductive region. In any event, it will be appreciated that the non-conductive region is a region free from conductive material or empty of conductive material.

The non-conductive region may be defined opposite the first location along the Z-direction. That is, because the non-conductive region is surrounded by the second conductive layer but is not conductive, the non-conductive region is non-capacitive and outside of the overlapping area between the first conductive layer and the second conductive layer. Thus, when the first location, where the first via connects with the first conductive layer, is defined opposite the non-conductive region, the first via connects with the first conductive layer outside of the overlapping area. Further, if the first via partially or fully punctures the first conductive layer, the negative effects such punch through of the first via (such as shorting out the capacitor, etc.) are avoided because such punch through occurs in a non-capacitive area (i.e., at the non-conductive region of the opposite layer).

The non-conductive region has an area in a plane defined by the X-direction and the Y-direction. In some embodiments, the area of the non-conductive region is at least the same as or equal to a cross-sectional area of the first via, such as at least about two times the cross-sectional area of the first via (or twice the cross-sectional area of the first via), such as at least about three times the cross-sectional area of the first via, such as at least about four times the cross-sectional area of the first via, or such as at least about five times the cross-sectional area of the first via.

It will be appreciated that, in some embodiments, the multilayer electronic component may define more than one non-conductive region, with a number of non-conductive regions corresponding to a number of vias connected with the capacitor. As one example, a first non-conductive region may be defined in the second conductive layer, and a second non-conductive region may be defined in the first conductive layer. A first via may connect with the first conductive layer at a first location opposite the first non-conductive region along the Z-direction, and a second via may connect with the second conductive layer at a second location opposite the second non-conductive region along the Z-direction.

In some embodiments, the dielectric material of the plurality of dielectric layers is disposed between the first conductive layer and the second conductive layer. For example, one or more dielectric layers of the plurality of dielectric layers may be disposed between the first conductive layer and the second conductive layer.

The multilayer electronic component may include one or more dielectric materials, such as the dielectric material of the plurality of dielectric layers. For example, the multilayer electronic component may include at least one layer of a first dielectric material between electrodes or conductive layers of the capacitor. The first dielectric material may be distinct from a second dielectric material of another layer of the multilayer electronic component, such as a dielectric layer over which an inductor is formed, in embodiments in which the multilayer electronic component is a filter. For example, the first dielectric material between the capacitor electrodes may comprise a ceramic-filled epoxy. The first dielectric material may have a dielectric constant that ranges from about 5 to about 9, in some embodiments from about 6 to about 8. The second dielectric material may comprise an organic dielectric material, for example, as described above. The second dielectric material may have a dielectric constant that ranges from about 1 to about 5, in some embodiments from about 2 to about 4. In other embodiments, however, the same dielectric material may be used for each dielectric layer of the multilayer electronic component.

In some embodiments, one or more dielectric materials of the multilayer electronic component may have a low dielectric constant (K). The dielectric constant may be less than about 100, in some embodiments less than about 75, in some embodiments less than about 50, in some embodiments less than about 25, in some embodiments less than about 15, and in some embodiments less than about 5. For example, in some embodiments, the dielectric constant may range from about 1.5 and 100, in some embodiments from about 1.5 to about 75, and in some embodiments from about 2 to about 8. The dielectric constant may be determined in accordance with IPC TM-650 2.5.5.3 at an operating temperature of 25° C. and frequency of 1 MHz. The dielectric loss tangent may range from about 0.001 to about 0.04, in some embodiments from about 0.0015 to about 0.0025.

In other embodiments, however, one or more dielectric materials of the multilayer electronic component may have a relatively high dielectric constant (K). For example, one or more dielectric materials of the multilayer electronic component may be NPO (COG), X7R, X5R X7S, Z5U, Y5V, or strontium titanate. In such examples, the dielectric material may have a dielectric constant that is greater than 100, for example, within a range from between about 100 to about 4000. In some embodiments, the dielectric constant of a dielectric material of the multilayer electronic component may range from about 1000 to about 3000.

In some embodiments, the one or more dielectric materials may include organic dielectric materials. Example organic dielectric include polyphenyl ether (PPE) based materials, such as LD621 from Polyclad and N6000 series from Park/Nelco Corporation, liquid crystalline polymer (LCP), such as LCP from Rogers Corporation or W. L. Gore & Associates, Inc., hydrocarbon composites, such as 4000 series from Rogers Corporation, and epoxy-based laminates, such as N4000 series from Park/Nelco Corp. For instance, examples include epoxy based N4000-13, bromine-free material laminated to LCP, organic layers with high K material, unfilled high-K organic layers, Rogers 4350, Rogers 4003 material, and other thermoplastic materials such as polyphenylene sulfide resins, polyethylene terephthalate resins, polybutylene terephthalate resins, polyethylene sulfide resins, polyether ketone resins, polytetraflouroethylene resins and graft resins, or similar low dielectric constant, low-loss organic material.

In some embodiments, the dielectric material may be a polymer or an epoxy, such as a ceramic-filled epoxy. For example, the dielectric material may include an organic compound, such as a polymer (e.g., an epoxy) and may contain particles of a ceramic dielectric material, such as barium titanate, calcium titanate, zinc oxide, alumina with low-fire glass, or other suitable ceramic or glass-bonded materials.

Other materials may be utilized, however, including, N6000, epoxy based N4000-13, bromine-free material laminated to LCP, organic layers with high K material, unfilled high-K organic layers, Rogers 4350, Rogers 4003 material (from the Rogers Corporation), and other thermoplastic materials such as hydrocarbon, Teflon, FR4, epoxy, polyamide, polyimide, and acrylate, polyphenylene sulfide resins, polyethylene terephthalate resins, polybutylene terephthalate resins, polyethylene sulfide resins, polyether ketone resins, polytetraflouroethylene resins, BT resin composites (e.g., Speedboard C), thermosets (e.g., Hitachi MCL-LX-67F), and graft resins, or similar low dielectric constant, low-loss organic material.

Additionally, in some embodiments, non-organic dielectric materials may be used in the multilayer electronic component, including ceramic, semi-conductive, or insulating materials, such as, but not limited to, sapphire, ruby, alumina (Al₂O₃), aluminum nitride (AlN), beryllium oxide (BeO), aluminum oxide (Al₂O₃), boron nitride (BN), silicon (Si), silicon carbide (SiC), silica (SiO₂), silicon nitride (Si₃N₄), gallium arsenide (GaAs), gallium nitride (GaN), zirconium dioxide (ZrO₂), mixtures thereof, oxides and/or nitrides of such materials, or any other suitable ceramic material. Additional example ceramic materials include barium titanate (BaTiO₃), calcium titanate (CaTiO₃), zinc oxide (ZnO), ceramics containing low-fire glass, or other glass-bonded materials. Dielectric materials such as diamond may be used as well.

The present disclosure also includes methods of forming a multilayer electronic component. In some embodiments, a method includes providing a plurality of dielectric layers; forming a first conductive layer overlying one of the plurality of dielectric layers; forming a second conductive layer overlying another of the plurality of dielectric layers and spaced apart from the first conductive layer in a Z-direction; stacking the plurality of dielectric layers such that the first conductive layer overlaps the second conductive layer in each of an X-direction and a Y-direction at an overlapping area to form a capacitor; and forming a first via connected with the first conductive layer at a first location outside of the overlapping area. It will be appreciated that the X-direction may be perpendicular to the Y-direction, and each of the X-direction and the Y-direction may be perpendicular to the Z-direction.

In some embodiments, a method of forming a multilayer electronic component may also include forming a second via connected with the second conductive layer at a second location outside of the overlapping area. In other embodiments, a method of forming a multilayer electronic component may also include forming a non-conductive region surrounded by the second conductive layer. As described in greater detail above, the non-conductive area can be defined opposite the first location along the Z-direction.

The multilayer electronic component may be any suitable multilayer component including a capacitor. For example, the multilayer electronic component may be a capacitor, a filter, an RC component, etc. In embodiments in which the multilayer electronic component is a filter, the filter may include a signal path having an input and an output and including one or more conductive layers overlying one or more dielectric layers. In such embodiments, the one or more vias of the multilayer electronic component as described herein may be used to route signals along the signal path to the capacitor. The multilayer filter may be configured for operation at high frequencies, for example, the multilayer filter may have a characteristic frequency (e.g., a low pass frequency, a high pass frequency, an upper bound of a bandpass frequency, or a lower bound of the bandpass frequency) that is greater than about 6 GHz, such as greater than about 10 GHZ, greater than about 15 GHZ, greater than about 25 GHz, greater than about 35 GHz, greater than about 40 GHZ, greater than about 45 GHZ, greater than about 50 GHz, greater than about 60 GHZ, greater than about 70 GHZ, or greater than about 80 GHz.

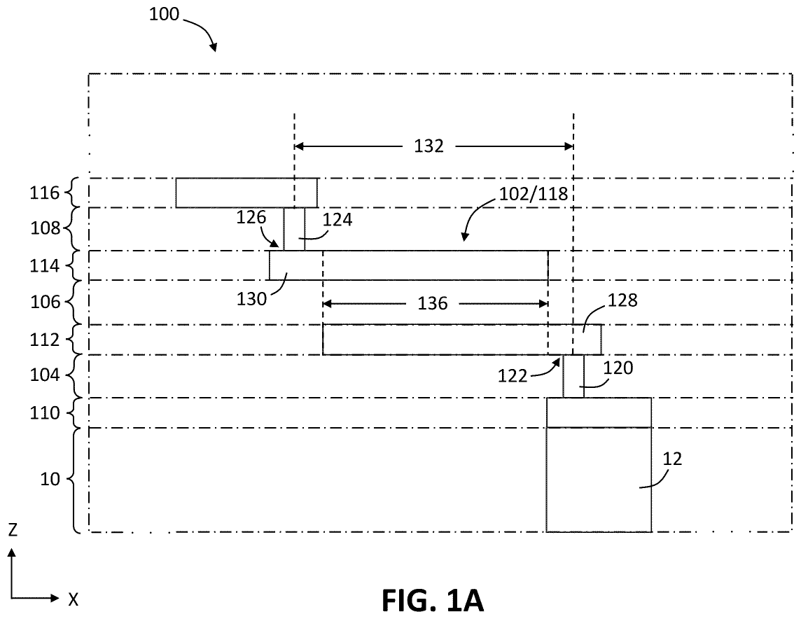

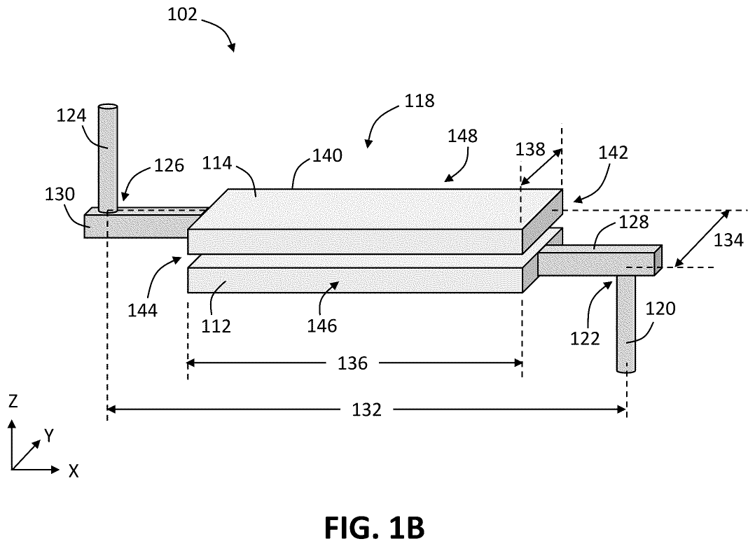

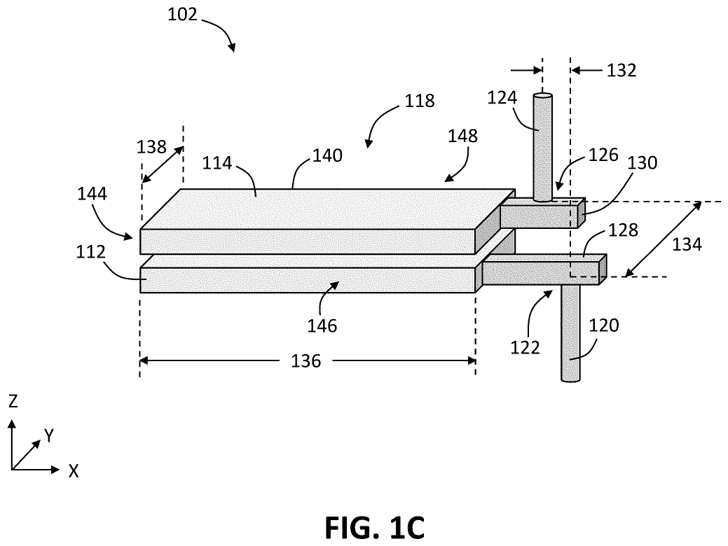

Referring now to the figures, various embodiments of the present invention will now be described in more detail. FIG. 1A provides a schematic side view of a portion of a multilayer electronic component 100 including a capacitor 102, with a plurality of dielectric layers of the multilayer electronic component 100 shown as transparent for clarity. FIG. 1B provides a schematic perspective view of the capacitor 102 of the multilayer electronic component 100 connected with two vias according to one embodiment of the present subject matter, and FIG. 1C provides a schematic perspective view of the capacitor 102 of the multilayer electronic component 100 connected with two vias according to another embodiment of the present subject matter.

As shown in FIG. 1A, the multilayer electronic component 100 includes a first dielectric layer 104, a second dielectric layer 106, and a third dielectric layer 108 that are stacked along a Z-direction, which is perpendicular to an X-direction. The multilayer electronic component 100 is mounted to a mounting device 10, which may be a printed circuit board (PCB) or the like. Conductive layers 110, 112, 114, 116 may be formed over or overlie the dielectric layers 104, 106, 108. Each conductive layer 110, 112, 114, 116 extends in the X-direction, as well as a Y-direction that is perpendicular to the X-direction, as shown in FIGS. 1B and 1C. The conductive layers 110, 112, 114, 116 may be formed from one or more conductive materials using any suitable process or technique, such as the conductive materials and processes or techniques described above, and the dielectric layers 104, 106, 108 may be formed from one or more dielectric materials, such as the dielectric materials described above.

It will be appreciated that FIG. 1A illustrates only a portion of the multilayer electronic component 100, such that the multilayer electronic component 100 may include dielectric layers in addition to the illustrated dielectric layers 104, 106, 108 and/or may include conductive layers in addition to the illustrated conductive layers 110, 112, 114, 116, as generally indicated by the dotted lines along the Z-direction. Further, it will be understood that one or more conductive layers, such as the conductive layers 110, 112, 114, 116 shown in FIG. 1A or additional conductive layers that are not depicted, may include conductive patterning in addition to the conductive patterning shown in FIG. 1A. For instance, the conductive layers 112, 114 shown in FIG. 1A are patterned to form a capacitor as described in more detail below, but one or both of the conductive layers 112, 114 could also include additional conductive material to define one or more additional elements of the multilayer electronic component 100, as generally indicated by the dotted lines along the X-direction. Thus, the dash-dot-dash lines in FIG. 1A generally indicate the boundaries of the multilayer electronic component 100 and the mounting device 10, although FIG. 1A may illustrate only a portion of the multilayer electronic component 100 and the mounting device 10.

In the depicted embodiment of FIG. 1A, a bottom conductive layer 110 is formed over a bottom surface of the first dielectric layer 104. In some embodiments, the bottom conductive layer 110 may be a contact pad or a ground plane that is exposed and/or terminated along a bottom surface of the multilayer electronic component 100 (e.g., the bottom surface of first dielectric layer 104). The mounting device 10 may include one or more terminals 12 for connection with the bottom conductive layer 110. For example, the bottom conductive layer 110 may be an output pad that directs an output signal from the multilayer electronic component 100 to the terminal 12 of the mounting device 10.

The conductive layer 112 may be a first conductive layer 112, and the conductive layer 114 may be a second conductive layer 114. As shown in FIGS. 1A, 1B, and 1C, the first conductive layer 112 is spaced apart from the second conductive layer 114 in the Z-direction, and the first conductive layer 112 overlaps with the second conductive layer 114 in each of the X-direction and the Y-direction at an overlapping area 118 to form the capacitor 102. In FIG. 1A, dashed lines are included to indicate the boundaries of the overlapping area 118 in the X-direction.

As illustrated in FIGS. 1A, 1B, and 1C, a first via 120 is connected with the first conductive layer 112 at a first location 122 outside of the overlapping area 118. A second via 124 is connected with the second conductive layer 114 at a second location 126 outside of the overlapping area 118. The first via 120 and the second via 124 may be hollow vias or filled vias (e.g., one via 120, 124 may be hollow and the other via 120, 124 may be filled, both vias 120, 124 may be hollow, or both vias 120, 124 may be filled) as described in greater detail elsewhere herein.

In the embodiment of FIG. 1A, the first via 120 extends through the first dielectric layer 104 to electrically connect the first conductive layer 112 with the bottom conductive layer 110. The second via 124 extends through the third dielectric layer 108 to electrically connect the second conductive layer 114 with the conductive layer 116, which may be referred to as the third conductive layer 116.

As shown in FIGS. 1A, 1B, and 1C, the first conductive layer 112 includes a first section 128 that defines the first location 122, and the second conductive layer 114 includes a second section 130 that defines the second location 126. The first section 128 is a portion of the conductive material of the first conductive layer 112 that extends beyond the overlapping area 118 in the X-direction and the Y-direction. Similarly, the second section 130 is a portion of the conductive material of the second conductive layer 114 that extends beyond the overlapping area 118 in the X-direction and the Y-direction.

The first section 128 and the second section 130 may be spaced apart from one another along one or both of the X-direction and the Y-direction. In FIGS. 1A, 1B, and 1C, the first location 122 and the second location 126 are spaced apart by a spacing distance 132 in the X-direction and a spacing distance 134 in the Y-direction. In the embodiment of FIGS. 1A and 1B, the overlapping area 118 has a length 136 in the X-direction that is less than the spacing distance 132 in the X-direction. However, in the embodiment of FIG. 1C, the length 136 of the overlapping area 118 is greater than the spacing distance 132 in the X-direction. As shown in FIGS. 1B and 1C, the overlapping area 118 has a width 138 in the Y-direction that is less than the spacing distance 134 in the Y-direction for each of the depicted embodiments. The spacing distances may be measured in any appropriate manner, such as between the centers of the first and second vias 120, 124 as described above.

As further shown in FIGS. 1A, 1B, and 1C, the first location 122 may be offset from the second location 126 along at least one of the X-direction or the Y-direction. For example, referring to FIG. 1A, the first location 122 (and the first section 128) is offset from the second location 126 (and second section 130) along at least the X-direction (the Y-direction is not shown in FIG. 1A). In FIGS. 1B and 1C, the first location 122 is offset from the second location 126 along both the X-direction and the Y-direction. It will be appreciated that, in other embodiments, the first location 122 and the second location 126 (and, thus, the first via 120 and the second via 124) may be aligned along the X-direction or the Y-direction.

Referring to FIGS. 1B and 1C, the overlapping area 118 that defines the capacitor 102 has a perimeter 140 that includes a first side 142 extending along the Y-direction, a second side 144 opposite the first side 142 along the X-direction, a third side 146 extending along the X-direction between the first side 142 and the second side 144, and a fourth side 148 opposite the third side 146 along the Y-direction. In the embodiment of FIG. 1B, the first section 128 extends from the first side 142 of the perimeter 140 such that the first location 122 is defined adjacent the first side 142, and the second section 130 extends from the second side 144 of the perimeter 140 such that the second location 126 is defined adjacent the second side 144. In the embodiment of FIG. 1C, both the first section 128 and the second section 130 extend from the second side 144 of the perimeter 140 such that the first location 122 and the second location 126 are both defined adjacent the second side 144.

Although not shown in the figures, in other embodiments, both the first section 128 and the second section 130 extend from the first side 142 such that the first location 122 and the second location 126 may both be defined adjacent the first side 142 of the perimeter 140. In still other embodiments, the first section 128 extends from the third side 146 of the perimeter 140 such that the first location 122 is defined adjacent the third side 146, and the second section 130 extends from the fourth side 148 of the perimeter 140 such that the second location 126 is defined adjacent the fourth side 148. In yet other embodiments, both the first section 128 and the second section 130 extend from the same side, such as from the third side 146 or the fourth side 148 of the perimeter 140, such that both the first location 122 and the second location 126 are both defined adjacent the third side 146 or both defined adjacent the fourth side 148.

As described elsewhere herein, the first via 120 and the second via 124 are connected to opposite conductive layers or plates of the capacitor 102, such that in embodiments where the first via 120 connects with the first conductive layer 112 adjacent the same side of the capacitor 102 or overlapping area 118 as the second via 124 connects with the second conductive layer 114 (such as one of the first side 142, second side 144, third side 146, or fourth side 148), the first via 120 and the second via 124 are offset from one another to avoid or prevent partial or full punch through of the first via 120 and/or the second via 124, which could lead to a short or other power vulnerability. That is, the first location 122 and the second location 126 are offset or spaced apart from one another along at least one of the X-direction or the Y-direction to offset the first via 120 from the second via 124. Thus, even if the first via 120 and the second via 124 both connect to the capacitor 102 adjacent the same side of the overlapping area 118, the possibility of a power vulnerability such as a short can be avoided because the first location 122 of the first via 120 and the second location 126 of the second via 124 are separated from one another along at least one of the X-direction or the Y-direction. In some embodiments, such as illustrated in FIGS. 1B and 1C, the first location 122 and the second location 126 may be separated from one another along both the X-direction and the Y-direction, even if the first location 122 and the second location 126 are both defined adjacent to the same side of the overlapping area 118 as shown in FIG. 1C.

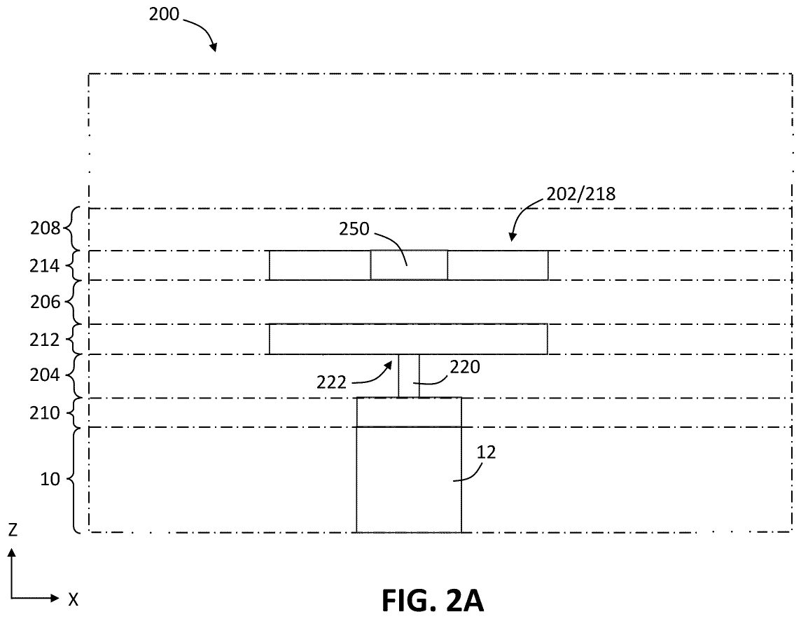

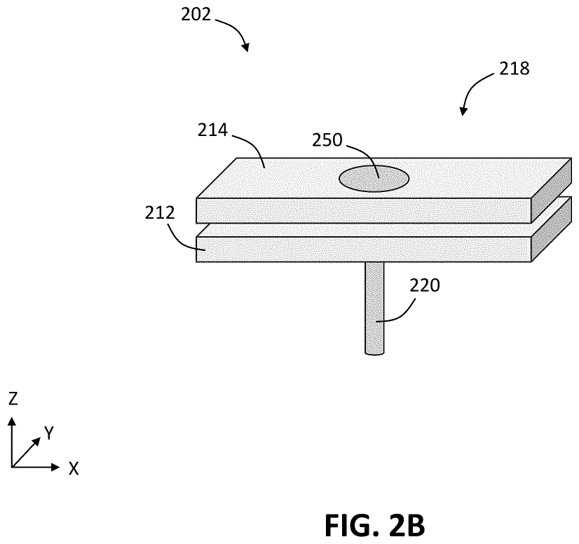

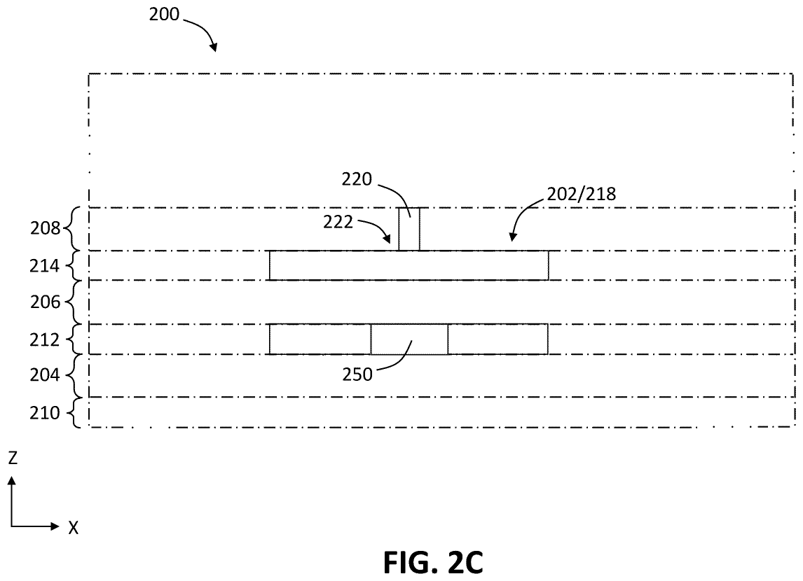

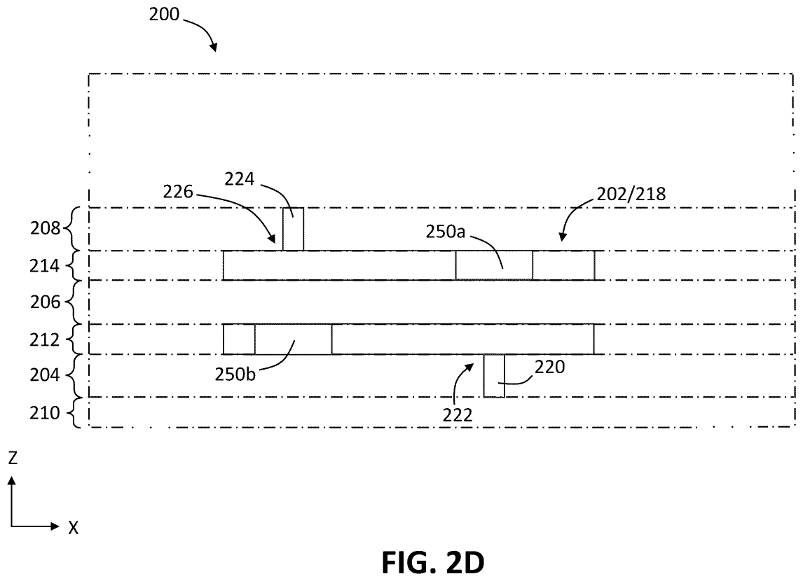

Turning now to FIGS. 2A through 2D, FIG. 2A provides a schematic side view of a portion of a multilayer electronic component 200 including a capacitor 202, with a plurality of dielectric layers of the multilayer electronic component 200 shown as transparent for clarity. FIG. 2B provides a schematic perspective view of the capacitor 202 of the multilayer electronic component 200 with a via connected to the capacitor 202 opposite a non-conductive region according to one embodiment of the present subject matter. FIGS. 2C and 2D each provide schematic side views of a portion of the multilayer electronic component 200 including the capacitor 202, with the plurality of dielectric layers shown as transparent for clarity, according to other embodiments of the present subject matter. It will be appreciated that the same or similar reference numerals are used in FIGS. 2A through 2D to denote the same or similar features as described with respect to FIGS. 1A, 1B, and 1C.

As shown in FIGS. 2A, 2C, and 2D, the multilayer electronic component 200 includes a first dielectric layer 204, a second dielectric layer 206, and a third dielectric layer 208 that are stacked along a Z-direction, which is perpendicular to an X-direction. The multilayer electronic component 200 is mounted to a mounting device 10, which may be a printed circuit board (PCB) or the like. Conductive layers 210, 212, 214 may be formed over or overlie the dielectric layers 204, 206, 208. Each conductive layer 210, 212, 214 extends in the X-direction, as well as a Y-direction that is perpendicular to the X-direction, as shown in FIG. 2B. The conductive layers 210, 212, 214 may be formed from one or more conductive materials using any suitable process or technique, such as the conductive materials and processes or techniques described above, and the dielectric layers 204, 206, 208 may be formed from one or more dielectric materials, such as the dielectric materials described above. Further, as described with respect to the multilayer electronic component 100, it will be appreciated that FIGS. 2A, 2C, and 2D illustrate only a portion of the multilayer electronic component 200, such that the multilayer electronic component 200 may include dielectric layers in addition to the illustrated dielectric layers 204, 206, 208 and/or may include conductive layers in addition to the illustrated conductive layers 210, 212, 214, as well as conductive patterning in addition to the illustrated conductive material of the conductive layers 210, 212, 214.

In the depicted embodiments of FIG. 2A, a bottom conductive layer 210 is formed over a bottom surface of the first dielectric layer 204. In some embodiments, the bottom conductive layer 210 may be a contact pad or a ground plane that is exposed and/or terminated along a bottom surface of the multilayer electronic component 200 (e.g., the bottom surface of dielectric layer 204). The mounting device 10 may include one or more terminals 12 for connection with the bottom conductive layer 210. For example, the bottom conductive layer 210 may be an output pad that directs an output signal from the multilayer electronic component 200 to the terminal 12 of the mounting device 10.

The conductive layer 212 may be a first conductive layer 212, and the conductive layer 214 may be a second conductive layer 214. As shown in FIGS. 2A through 2D, the first conductive layer 212 is spaced apart from the second conductive layer 214 in the Z-direction. The first conductive layer 212 overlaps with the second conductive layer 214 in each of the X-direction and the Y-direction at an overlapping area 218 to form the capacitor 202.

In the embodiments of FIGS. 2A, 2B, 2C, and 2D, a via 220 is connected with a conductive layer, such as the first conductive layer 212 or the second conductive layer 214, and a non-conductive region 250 is defined within the opposite conductive layer, such as the second conductive layer 214 for a via 220 connected to the first conductive layer 212 or the first conductive layer 212 for a via 220 connected to the second conductive layer 214, such that the opposite conductive layer surrounds the non-conductive region 250. The via 220 connects with the conductive layer at a location opposite the non-conductive region 250 along the Z-direction.

As an example, referring to the embodiment of FIGS. 2A and 2B, the multilayer electronic component 200 includes a non-conductive region 250 surrounded by the second conductive layer 214, and the via 220 connects with the first conductive layer 212 opposite the non-conductive region 250. For instance, the non-conductive region 250 overlies the same dielectric layer as the second conductive layer 214, and the second conductive layer 214 is defined around the non-conductive region 250. It will be appreciated that the second conductive layer 214 may be formed over a bottom surface of the third dielectric layer 208 or over a top surface of the second dielectric layer 206. As another example, referring to FIG. 2C, the multilayer electronic component 200 includes a non-conductive region 250 surrounded by the first conductive layer 212, and the via 220 connects with the second conductive layer 214 opposite the non-conductive region 250. As described elsewhere herein, the non-conductive region 250 may be formed from a dielectric material or another material that is electrically non-conductive; the non-conductive region 250 is a region free from conductive material or empty of conductive material.

As stated, the non-conductive region 250 is defined opposite along the Z-direction the location 222 where the via 220 connects with the respective conductive layer. Because the non-conductive region 250 is surrounded by conductive material but is not conductive, the non-conductive region 250 is a non-capacitive region and is outside of the overlapping area 218 between the first conductive layer 212 and the second conductive layer 214. Thus, when the location 222 where the via 220 connects with the respective conductive layer is opposite the non-conductive region 250, the via 220 connects with the respective conductive layer outside of the overlapping area 218. As a result, if the via 220 partially or fully punctures the conductive layer 212, 214 the via 220 intersects, the negative effects of such punch through are avoided because such punch through occurs in a non-capacitive area, the non-conductive region 250 of the opposite plate of the capacitor 202.

The non-conductive region 250 has an area in a plane defined by the X-direction and the Y-direction. Referring to FIG. 2B, the non-conductive region 250 has a substantially circular shape, such that the area of the non-conductive region 250 is equal to pi (TT) times a radius of the non-conductive region 250 squared (area=πr²). In other embodiments, the non-conductive region 250 may be generally square or rectangular, such that the area of the non-conductive region 250 is equal to a length of the non-conductive region in the X-direction times the width of the non-conductive region in the Y-direction (area=L*W). The area of the non-conductive region 250 is at least the same as or equal to a cross-sectional area of the via 220, such as 1×, 2×, 3×, 4×, 5×, or more (one time, two times, three times, four times, five times, or more) the cross-sectional area of the via 220.

Referring to FIG. 2D, in some embodiments, the multilayer electronic component 200 may define more than one non-conductive region 250. For example, a number of non-conductive regions 250 can corresponding to a number of vias connected with the capacitor 202. As depicted in FIG. 2D, a first non-conductive region 250a is defined in the second conductive layer 214, and a second non-conductive region 250b is defined in the first conductive layer 212. A first via 220 connects with the first conductive layer 212 at a first location 222 opposite the first non-conductive region 250a along the Z-direction. A second via 224 connects with the second conductive layer 214 at a second location 226 opposite the second non-conductive region 250b along the Z-direction. It will be understood that the number of non-conductive regions 250 and vias 220, 224 shown in FIG. 2D is by way of example only, and in other embodiments, additional non-conductive regions 250 may be defined in the capacitor 202 to correspond to the number of vias connected with the capacitor 202.

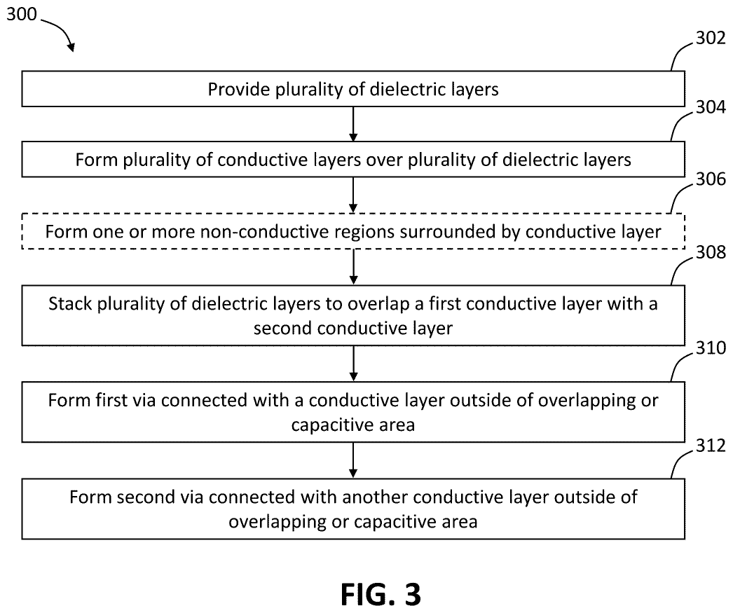

Turning now to FIG. 3, the present disclosure also includes methods of forming a multilayer electronic component, such as a multilayer electronic component 100 or a multilayer electronic component 200 as described herein. As shown in FIG. 3, a method 300 of forming a multilayer electronic component 100, 200 includes (302) providing a plurality of dielectric layers, such as dielectric layers 104, 106, 108 or dielectric layers 204, 206, 208. The method 300 also includes (304) forming a plurality of conductive layers 110, 112, 114, 116/210, 212, 214 overlying dielectric layers of the plurality of dielectric layers 104, 106, 108/204, 206, 208. For instance, the method 300 can include forming a first conductive layer 112, 212 overlying one of the plurality of dielectric layers and forming a second conductive layer 114, 214 overlying another of the plurality of dielectric layers and spaced apart from the first conductive layer 112, 212 in a Z-direction.

In some embodiments, the method 300 optionally includes (306) forming one or more non-conductive regions 250 surrounded by a conductive layer. For example, as described with respect to the multilayer electronic component 200, the method 300 may include forming or defining a non-conductive region 250 in the first conductive layer 212 of the multilayer electronic component 200 such that conductive material of the first conductive layer 212 surrounds the non-conductive region 250. Alternatively, or additionally, in some embodiments the method 300 includes forming or defining a non-conductive region 250 in the second conductive layer 214 of the multilayer electronic component 200 such that conductive material of the second conductive layer 214 surrounds the non-conductive region 250.

As shown at (308) in FIG. 3, the method 300 includes stacking the plurality of dielectric layers 104, 106, 108/204, 206, 208 such that the first conductive layer 112, 212 overlaps the second conductive layer 114, 214 in each of an X-direction and a Y-direction at an overlapping area 118, 218 to form a capacitor 102, 202. The method 300 further includes (310) forming a via 120, 220 connected with a conductive layer at a location outside of the overlapping area 118, 218. For example, the via may be a first via 120 connected with the first conductive layer 112 at a first location 122 outside of the overlapping area 118. As another example, the via may be a via 220 connected with either the first conductive layer 212 or the second conductive layer 214 at a location 222 opposite the non-conductive region 250 such that the via 220 is connected outside of the overlapping or capacitive area 218.

The method 300 optionally includes (312) forming a second via 124, 224 connected with the second conductive layer 114, 214 at a second location 126, 226 outside of the overlapping area 118, 218. For example, as described with respect to FIGS. 1A through 1C, in some embodiments, a first via 120 is connected with the first conductive layer 112 at a first section 128 of the first conductive layer 112 that extends beyond the overlapping area 118 in the X-direction and the Y-direction. Similarly, a second via 124 is connected with the second conductive layer 114 at a second section 130 of the second conductive layer 114 that extends beyond the overlapping area 118 in the X-direction and the Y-direction. In other embodiments, as described with respect to FIG. 2D, the multilayer electronic component 200 may include a plurality of non-conductive regions 250, such as a first non-conductive region 250a and a second non-conductive region 250b, which are each outside of the overlapping area 218, or capacitive area, because they are non-conductive. For instance, as shown in FIG. 2D, a first via 220 connects with the capacitor 202 at a location 222 opposite the first non-conductive region 250a, and a second via 224 connects with the capacitor 202 at a location 226 opposite the second non-conductive region 250b.

The various embodiments of the multilayer electronic component described herein may find application in any suitable type of electrical device. For instance, a multilayer filter having a capacitor as described herein may find particular application in devices that receive, transmit, or otherwise employ high frequency radio signals. Example applications include smartphones, signal repeaters (e.g., small cells), relay stations, and radar.

These and other modifications and variations of the present disclosure may be practiced by those of ordinary skill in the art, without departing from the spirit and scope of the present disclosure. In addition, it should be understood that aspects of the various embodiments may be interchanged both in whole and in part. Moreover, those of ordinary skill in the art will appreciate that the foregoing description is by way of example only and is not intended to limit the disclosure so further described in such appended claims.

What is claimed is:

1. A multilayer electronic component, comprising:
a plurality of dielectric layers stacked in a Z-direction that is perpendicular to each of an X-direction and a Y-direction, the X-direction perpendicular to the Y-direction, the plurality of dielectric layers comprising a dielectric material;
a first conductive layer overlying one of the plurality of dielectric layers;
a second conductive layer overlying another of the plurality of dielectric layers and spaced apart from the first conductive layer in the Z-direction, the second conductive layer overlapping the first conductive layer in each of the X-direction and the Y-direction at an overlapping area to form a capacitor; and
a first via connected with the first conductive layer at a first location outside of the overlapping area.

2. The multilayer electronic component of claim 1, further comprising:
a second via connected with the second conductive layer at a second location outside of the overlapping area.

3. The multilayer electronic component of claim 2, wherein the first location is offset from the second location along at least one of the X-direction or the Y-direction.

4. The multilayer electronic component of claim 2, wherein the first conductive layer includes a first section that defines the first location and the second conductive layer includes a second section that defines the second location, and wherein the first section and the second section are spaced apart from one another along the X-direction and the Y-direction.

5. The multilayer electronic component of claim 4, wherein the first location and the second location are spaced apart by a spacing distance in the X-direction, and wherein the overlapping area has a length in the X-direction that is less than the spacing distance.

6. The multilayer electronic component of claim 4, wherein the first location and the second location are spaced apart by a spacing distance in the X-direction, and wherein the overlapping area has a length in the X-direction that is greater than the spacing distance.

7. The multilayer electronic component of claim 4, wherein the first location and the second location are spaced apart by a spacing distance in the Y-direction, and wherein the overlapping area has a width in the Y-direction that is greater than the spacing distance.

8. The multilayer electronic component of claim 2, wherein the overlapping area comprises a first side and a second side opposite the first side along the X-direction, and wherein the first location is defined adjacent the first side and the second location is defined adjacent the second side.

9. The multilayer electronic component of claim 2, wherein the overlapping area comprises a first side and a second side opposite the first side along the X-direction, and wherein both the first location and the second location are defined adjacent one of the first side or the second side, the first location and the second location spaced apart from one another along the Y-direction.

10. The multilayer electronic component of claim 2, wherein the overlapping area comprises a third side and a fourth side opposite the third side along the Y-direction, and wherein the first location is defined adjacent the third side and the second location is defined adjacent the fourth side.

11. The multilayer electronic component of claim 2, wherein the overlapping area comprises a third side and a fourth side opposite the third side along the Y-direction, and wherein both the first location and the second location are defined adjacent one of the third side or the fourth side, the first location and the second location spaced apart from one another along the X-direction.

12. The multilayer electronic component of claim 1, further comprising:
a non-conductive region surrounded by the second conductive layer, the non-conductive region defined opposite the first location along the Z-direction.

13. The multilayer electronic component of claim 12, wherein the non-conductive region has an area that is at least two times a cross-sectional area of the first via.

14. The multilayer electronic component of claim 1, wherein the dielectric material is disposed between the first conductive layer and the second conductive layer.

15. The multilayer electronic component of claim 14, wherein the dielectric material is an organic dielectric material.

16. The multilayer electronic component of claim 15, wherein the organic dielectric material comprises at least one of liquid crystalline polymer or polyphenyl ether.

17. A method of forming a multilayer electronic component, the method comprising:
providing a plurality of dielectric layers;
forming a first conductive layer overlying one of the plurality of dielectric layers;
forming a second conductive layer overlying another of the plurality of dielectric layers and spaced apart from the first conductive layer in a Z-direction;
stacking the plurality of dielectric layers such that the first conductive layer overlaps the second conductive layer in each of an X-direction and a Y-direction at an overlapping area to form a capacitor, the X-direction perpendicular to the Y-direction and each of the X-direction and the Y-direction perpendicular to the Z-direction; and
forming a first via connected with the first conductive layer at a first location outside of the overlapping area.

18. The method of claim 17, further comprising:
forming a second via connected with the second conductive layer at a second location outside of the overlapping area.

19. The method of claim 17, further comprising:
forming a non-conductive region surrounded by the second conductive layer, the non-conductive region defined opposite the first location along the Z-direction.

20. A multilayer electronic component, comprising:
a plurality of dielectric layers stacked in a Z-direction that is perpendicular to each of an X-direction and a Y-direction, the X-direction perpendicular to the Y-direction, the plurality of dielectric layers comprising a dielectric material;
a first conductive layer overlying a first dielectric layer of the plurality of dielectric layers;
a second conductive layer overlying a second dielectric layer of the plurality of dielectric layers and spaced apart from the first conductive layer in the Z-direction, the second conductive layer overlapping the first conductive layer in each of the X-direction and the Y-direction at an overlapping area to form a capacitor;
a via connected with the first conductive layer; and
a non-conductive region defined on the second dielectric layer such that the second conductive layer surrounds the non-conductive region,
wherein the via connects with the first conductive layer at a location opposite the non-conductive region along the Z-direction.
